(19) United States
(12) Patent Application Publication
(10) Pub. No.: US 2005/0283327 A1
(43) Pub. Date: Dec. 22, 2005

(54) Breast feeding monitoring device and method

(76) Inventors: Catherine Mary Bowman, Mesa, AZ (US); Ernest Stewart Gale, Tucson, AZ (US)

Correspondence Address: WEISS & MOY PC, 4204 NORTH BROWN AVENUE, SCOTTSDALE, AZ, 85251, US

(21) Appl. No.: 10/932,372

(22) Filed: Jun. 21, 2004

(51) Int. Cl. G06F 19/00

(52) U.S. Cl. 702/81

(57) ABSTRACT

A device and method for collecting, analyzing, displaying and storing information relevant for determining the nutritional progress of a breastfed infant, including, but not limited to: time and duration of breast feedings, amount of breast milk or formula fed by bottle, time and frequency of wet and dirty diapers and length, weight and age of the infant.

### FIELD OF THE INVENTION

The present invention relates generally to nutritional health monitoring devices and methods and, more particularly, to a device and method that collects, analyzes, displays and stores information relevant to determining the nutritional health and progress of a breastfed infant.

### BACKGROUND OF THE INVENTION

Breast feeding mothers are particularly concerned about whether their infants are receiving adequate nutrition. Breast feeding is a confidence game, and nothing undermines a mother's confidence like being afraid her baby isn't getting enough milk. If the infant cries after feeding, the breast feeding mother, especially one unaccustomed to babies and breast feeding, is often concerned that her milk is not providing adequate nutrition or that the baby is not getting enough milk. Unfortunately, there are in fact cases where breast milk is insufficient, both in quantity and quality. Unlike formula fed babies, there is no measuring device or nutritional data available for a mother who is breast feeding her infant. Accordingly, mothers who breastfeed their babies are encouraged to keep track of frequency and duration of feeding, number of wet and/or soiled diapers, weight gain and other factors that doctors have determined indicate whether an infant is receiving adequate nutrition and to provide assurance to the mother that her milk is providing that nutrition.

For example, the breast feeding literature from La Leche, The Complete Book of Breastfeeding by Eiger and Wendkos, What to Expect the First Year, by Eisenberg, Murkoff and Hathaway and other recognized sources including the Academy of Pediatrics, provide guidelines to mothers to determine whether their breastfed infants are getting sufficient nutrition. These guidelines currently include:
Whether the infant nurses an average of 8-12 feedings per 24-hour period.
Whether feedings are on average 10 to 20 minutes per breast or longer.
Whether the infant has one to two wet diapers a day in first few days of life when the infant is feeding on colostrum.
Whether, if the breast feeding times have been deficient, the infant has been supplemented with adequate bottle feedings, with 2 ounces of pumped breast milk or formula equal to one breast feeding session.
Whether the infant has 6-8 wet cloth diapers or 5 to 6 wet disposable diapers per day by the third or fourth day of life when the infant is feeding on breast milk.
Whether the infant has two to five bowel movements per 24-hour period for the first few months.
Whether the infant gains at least 4-7 ounces per week after the fourth week of life.

Meeting these guidelines substantially ensures the nutritional health of the breastfed infant.

In many hospitals, healthy babies are no longer kept in nurseries. They typically stay with their mothers in private or semi-private rooms. The medical staff will require the mother to keep track of the time and duration of feedings and the time and frequency of wet and soiled diapers, particularly if an infant shows signs of dehydration while in the hospital. To assess the infant's nutritional progress, a pediatrician will often ask the mother for this information at the first doctor visit, which typically occurs within 48-72 hours of release from the hospital.

Currently, mothers or their helpers record this information manually on paper or on grease boards at the hospital because there is no device designed to conveniently capture the information. After childbirth, mothers are physically and emotionally drained and, depending on the circumstances of the birth, will be incapacitated to varying degrees. The required information is often not recorded contemporaneously because the mother is still bonding with the infant, the paper/pen used as a running record of the information is not readily available or the grease board is fixed to a wall in the hospital room and the mother is unable/unwilling to get out of bed immediately after breast feeding or changing the infant. For some mothers the lack of sleep that results from the 24-hour cycle of breast feeding in the first few months makes it difficult to remember with precision the specifics of the information to be recorded. If the information gathered is inaccurate or calculated incorrectly, the mother or medical professionals may miss early cues of nutritional deficiency in the breastfed infant.

While breast feeding is beneficial to both the infant and the mother, it can be physically and emotionally demanding upon the mother. The object and advantage of the present invention is to provide a device that conveniently and accurately collects information relevant to the nutritional health of the breast fed infant that is capable of collecting, analyzing, displaying and storing the data in a manner useful to the mother or other caretaker and health care professionals.

Accordingly, there exists a need for a device that can conveniently record the time of a feeding. There is a further need for a device that can electronically calculate the duration of a feeding. There is a still further need for a device that can electronically track both breast feeding and supplemental bottle feedings of either pumped breast milk or formula. There is an additional need for a device that can electronically calculate the frequency and duration of feedings and alert the user if the guidelines related to nutritional progress are not met. There is another need for a device that can conveniently record the time that the user changed a wet and/or soiled diaper. There is also a need for a device that can electronically calculate the frequency and type of infant secretion and alert the user if the guidelines related to nutritional progress are not met. There is a still further need for a device that can record an infant's length and weight and alert the user if the guidelines related to nutritional progress are not met. There is another need for a device that can electronically store, display and/or download information related to the nutritional progress of an infant. There is a further need for a device that can be attached to a bassinet, crib, infant blanket, diaper bag or other item associated with the infant and that is aesthetically pleasing and capable of being designed toward the interests of the mother or the infant. The present invention fulfills these needs and provides further related advantages.

### SUMMARY OF THE INVENTION

According to the present invention and exemplary embodiments thereof described herein, a device and method is provided to monitor and assess the nutritional progress of a breastfed infant. The device and method generally comprise a housing including a microprocessor for recording, analyzing, displaying and/or storing relevant information provided at a user interface for determining the nutritional progress of the breastfed infant.

In accordance with one embodiment of the present invention, a breast feeding monitoring device for monitoring the nutritional health of a breast feeding infant comprising, in combination: a housing; a microprocessor located within the housing; memory accessed by the microprocessor; wherein the memory stores a plurality of items of personal data relating to nutritional health of a breast feeding infant; wherein the memory further stores relevant target values for nutritional health of a breast feeding infant; a display located on a surface of the housing for providing a visual display of information relating to the nutritional health of a breast feeding infant; and individual data inputting means on the housing for inputting into the memory the personal data.

In accordance with another embodiment of the present invention, a method for monitoring the nutritional health of a breast feeding infant comprising the steps of: providing a monitoring device comprising, in combination: a housing; a microprocessor located within the housing; memory accessed by the microprocessor; wherein the memory stores a plurality of items of personal data relating to nutritional health of a breast feeding infant; wherein the memory further stores relevant target values for nutritional health of a breast feeding infant; a display located on a surface of the housing for providing a visual display of information relating to the nutritional health of a breast feeding infant; and individual data inputting means on the housing for inputting into the memory the personal data; accepting from a user of the device inputting of the plurality of items of personal data relating to the nutritional health of the breast feeding infant; and the device comparing the inputted plurality of items of personal data to the relevant target values.

In accordance with a further embodiment of the present invention, a method for monitoring the nutritional health of a breast feeding infant comprising the steps of: providing a monitoring device comprising, in combination: a housing; a microprocessor located within the housing; memory accessed by the microprocessor; wherein the memory stores a plurality of items of personal data relating to nutritional health of a breast feeding infant; wherein the memory further stores relevant target values for nutritional health of a breast feeding infant; a display located on a surface of the housing for providing a visual display of information relating to the nutritional health of a breast feeding infant; and individual data inputting means on the housing for inputting into the memory the personal data; accepting from a user of the device inputting of information relating to a number of breast feedings within a defined period of time for the breast feeding infant; accepting from the user of the device inputting of information relating to a duration of the breast feedings; accepting from the user of the device inputting of information relating to a number of wet diapers for the breast feeding infant; accepting from the user of the device inputting of information relating to a number of dirty diapers for the breast feeding infant; and the device comparing the inputted plurality of items of personal data to the relevant target values.

Other features and advantages of the invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a plan view of a monitoring device consistent with an embodiment of the present invention, illustrating a housing with an exemplary user interface, a display and an LED;

FIG. 2 is a block diagram of a monitoring system used by an embodiment of the device;

FIG. 3A is a flow diagram of main processing of an embodiment of the device;

FIG. 3B is a flow diagram illustrating an alert feature;

FIG. 3C is a flow diagram for a feeding function;

FIGS. 3D and 3E are flow diagrams for a diapering function;

FIG. 3F is a flow diagram illustrating set-up of the device;

FIG. 4A is a display for the main menu;

FIG. 4B is a display for the alert submenu;

FIG. 4C is a display for the feeding function; and

FIG. 4D is a display for the setup display.

### DETAILED DESCRIPTION OF THE PREFERRED EMBODIMENTS

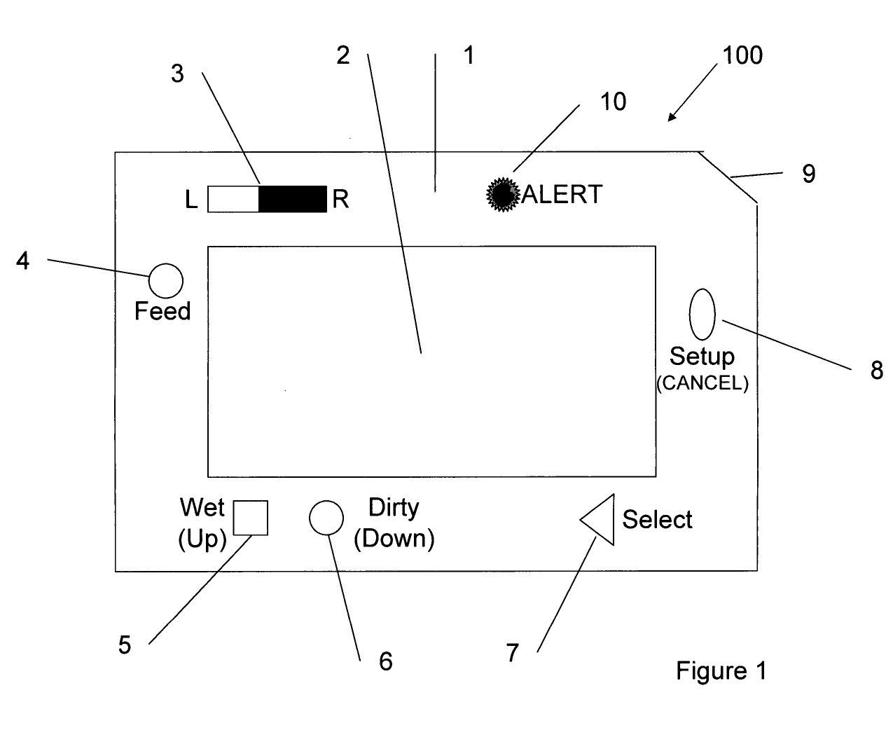

As shown in the drawings for purposes of illustration, a breast feeding monitoring device referred to generally in FIG. 1 by the reference numeral 100 is provided for monitoring the nutritional health of a breastfed infant. The device is designed to be relatively inexpensive and easy to use with a compact and portable configuration. The device provides one or more alerts if the data relating to frequency and duration of actual feedings and the frequency of actual dirty and wet diaper changes as inputted by a user do not meet the corresponding data relating to stored target values identified as indicative of whether a breastfed infant is receiving substantially adequate nutrition and milk.

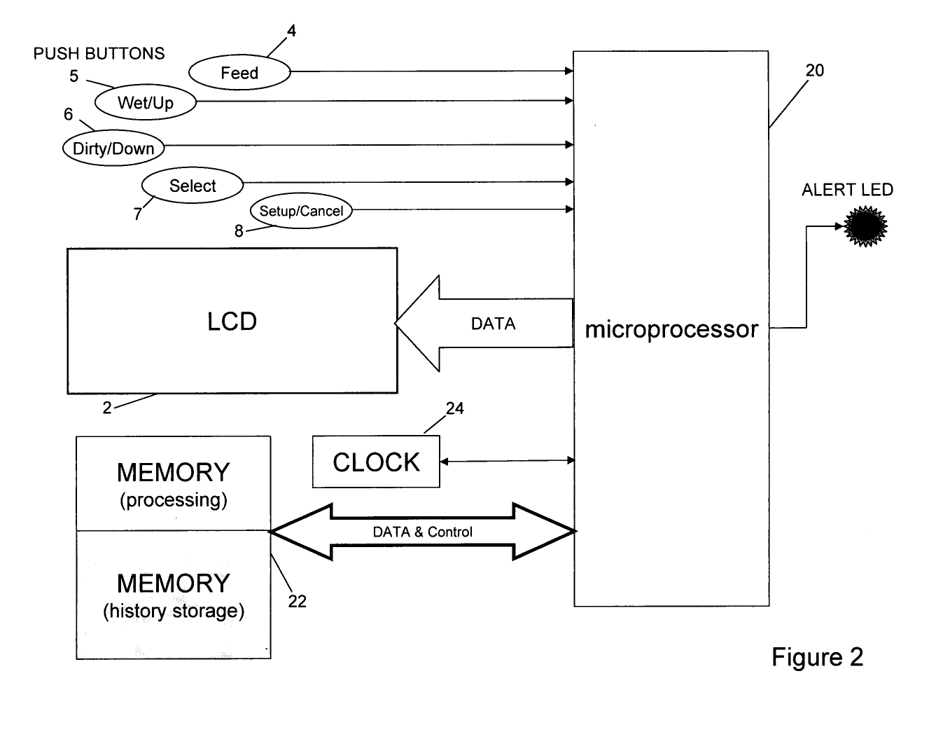

In accordance with the present invention, and as illustrated in FIGS. 1 and 2 with respect to a preferred embodiment, the device 100 generally comprises a housing 1 having a display 2, a microprocessor 20 (see FIG. 2) within the housing 1 for receiving and recording data from user input and from a memory 22 (See FIG. 2) and, by analyzing the actual values to determine whether the corresponding target values have been met, determining whether the infant is receiving substantially adequate nutrition and milk.

Preferably, the housing has a bottom plate or wall joined to a pair of sidewalls and a front wall including the display as hereinafter described. The housing should preferably be small and lightweight enough to fit into one hand or in a pocket. In the preferred embodiment, the housing may be substantially rectangular with dimensions of approximately 3 inches wide by 2.5 inches high by 1 inch deep. The housing may include an orientation feature such as the angled corner as shown in FIG. 1 enabling the user to properly orient the device in one's hand, even in low light. It is to be understood that other configurations and sizes may be used for the housing and the orientation feature.

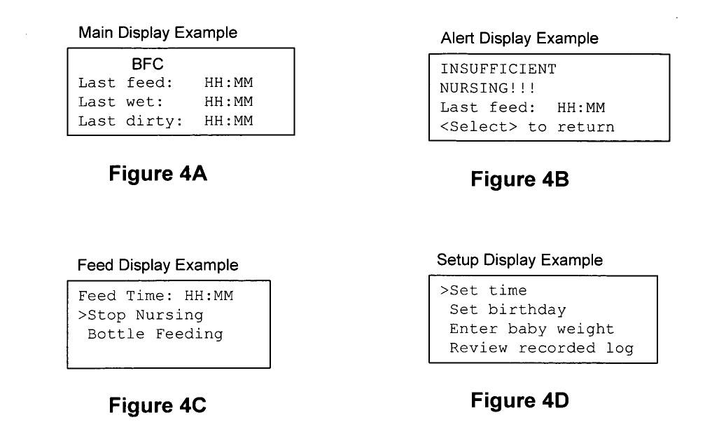

The display 2 may be a liquid crystal display (LCD) or other known type of display. The display 2 preferably includes a light, enabling use of the device in the dark. Preferably, the display 2 should be a minimum of 4 lines by 16 character display. The LCD (liquid crystal display) may be used to display alerts and user menus as shown in FIGS. 4A-4D. The external surface of the housing of the device may also include an LED (light emitting diode) 10 as shown in FIGS. 1 and 2 to provide another alert.

As illustrated in FIG. 1, the user input is received at a user interface on the front wall of the device 100. The user interface includes a plurality of input “keys”. In the preferred embodiment, these keys comprise push buttons on the external housing of the device 100 and may include a “Setup” button 8, a “Select” button 7, a “Feed” button 4, a “Wet” button 5 and a “Dirty” button 6. (As shown in FIG. 1, the Wet button 5 may also be used to scroll up displayed menus, and the Dirty button 6 may be used to scroll down displayed menus, before selecting a menu option by depressing the “Select” button 7. Generally, the buttons 5 and 6 are referred to herein by the function for which they are being utilized.) Although certain functions have been described, it is to be understood that if there is a change in the conventional wisdom regarding what personal data should be tracked in order to monitor the nutritional health of a breast fed infant, the device may be modified to collect the new data.

The push buttons may be used to initiate functions, navigate menus, and make selections as hereinafter described. Although push buttons have been described, it is to be understood that any type of known user input is included, including for example a touch screen and stylus, etc.

The user interface may further include a slide switch 3 indicating left to right to remind the user which breast to start feeding as it is desirable to start nursing from alternate breasts for consecutive feedings. (Recordation of the last breast used for a feeding may proceed in a different manner, for example by an electronic recording of such information.) The device 100 may include other functions or features such as a clock, alarm or otherwise, or the like. The features of the invention may also be provided on standard consumer electronics as an optional feature, such as on a cell phone, alarm clock, PDA, calculator, etc. (It may be desired to provide a cradle for the device 100, coupled to a personal computer or the like, so that the information within the device 100 can be uploaded to a computer, and/or so that desired information, such as updated target values or log information, can be downloaded from a computer to the device 100.)

The processor is a microprocessor available, for example, from Microchip, Phoenix, Ariz. A suitable Microchip microprocessor is a PIC processor, Model 18C252, although other microprocessors well known in the art may be used. The microprocessor is operated by calculating software well known in the art and includes real clock management, LCD control, and interrupt routines. The device 100 records the actual values associated with the nutritional health of a breastfed infant. For example, the device 100 as hereinafter described may track actual feeding and diapering events or functions to assess whether the corresponding target values are met. The target values associated with breast feeding may relate to the frequency and duration of feeding and frequency of diapering events and include, but are not limited to:
Feeding events: Total nursings in the previous 24 hours equal at least 8;
   Total feeding time over the previous 24 hours is 15 minutes×8 nursings=120 minutes in the previous 24 hours (if less, supplemental feeding history is analyzed for sufficiency);
Diapering events: <3 days old, at least one wet diapers in previous 24 hours; and
>3 days old, at least 6 wet diapers and at least 2 soiled diapers (stool output/bowel movements) in previous 24 hours.

Any other function associated with the health of an infant may also serve as a recorded function/target value in accordance with the present invention, the particular type of function not being limited to those described herein. For example, actual Apgar scores or hearing test results May be recorded and assessed against target values therefor.

As shown in FIG. 2, the microprocessor uses memory for two main functions. The first is primary memory for general processing such as maintaining the LCD and the user menus, monitoring push button activity, and analyzing recorded events for alerts and/or displaying and summarizing information. The second function is to record time stamps and events that are to be analyzed for alerts. There should preferably be sufficient memory storage to contain about six months of time stamps and feeding/diapering events, although other durations are possible. The memory storage for time stamps is preferably non-volatile memory (EEPROM) which is substantially safe from power loss. The memory also stores the plurality of recorded and target values associated with breast feeding.

A real time internal clock 24 (FIG. 2) is maintained by the processor to record actual feeding and diaper change times. The internal clock may be used to time stamp feedings, diaper changes, and child weights. The internal clock is also used as a counter to count elapsed feeding times. The microprocessor calculates elapsed time.

The microprocessor monitors the push buttons for user input. The meaning of the buttons is context sensitive, but generally leads to the device recording an event and the actual time. As shown in FIG. 2, the microprocessor receives data input from the user via a set of push buttons and from the memory and outputs to the display, the memory and the LED. The set of push buttons sends signals to the microprocessor to activate some functions such as counting minutes, etc., and the microprocessor sends a signal of results (a result of the counting) to show on the display. The microprocessor monitors the saved history of actual events in the memory against the current time to determine whether alert conditions apply. If a condition is identified that requires the user to be notified, an alert is shown on the display and the LED (light emitting diode) blinks continuously until the alert is acknowledged by the user at which time the device reverts to the main menu.

The device may be operated by a known power source (not shown) such as batteries with an appropriate on-off switch mounted on the housing exterior. Low power operation is desired to enable the use of smaller batteries and therefore a smaller device. Rechargeable batteries may be used. Electrical power for the device may also be conveniently obtained from an electrical outlet (not shown) via a power cord and plug, but this of course limits its portability.

The device may be carried or worn by the caretaker in a pocket or with a clip or the like. The device preferably fits into one hand. Alternatively, the device may be built into a bed, other furniture, or on a stand to be placed in close proximity to the infant. The device may be personalized to the infant or the personal taste of the mother or caregiver.

To use the device 100, the device 100 awaits an interrupt from a push button. In one embodiment, the user holds the Select button 7 for one second continuously to wake up the device 100, though it should be noted that one or more other buttons may be enabled to perform an interrupt function. This avoids the unintended recording of information or inadvertent and power wasting display cycles. After waking up the device 100, the main menu will be displayed as shown in FIG. 4A. The main menu will normally display the times of the last feeding and wet and dry diaper changes as well as any identified alerts. The device 100 will return to standby mode as hereinafter described in about two minutes if there are no user inputs following display of the main menu.

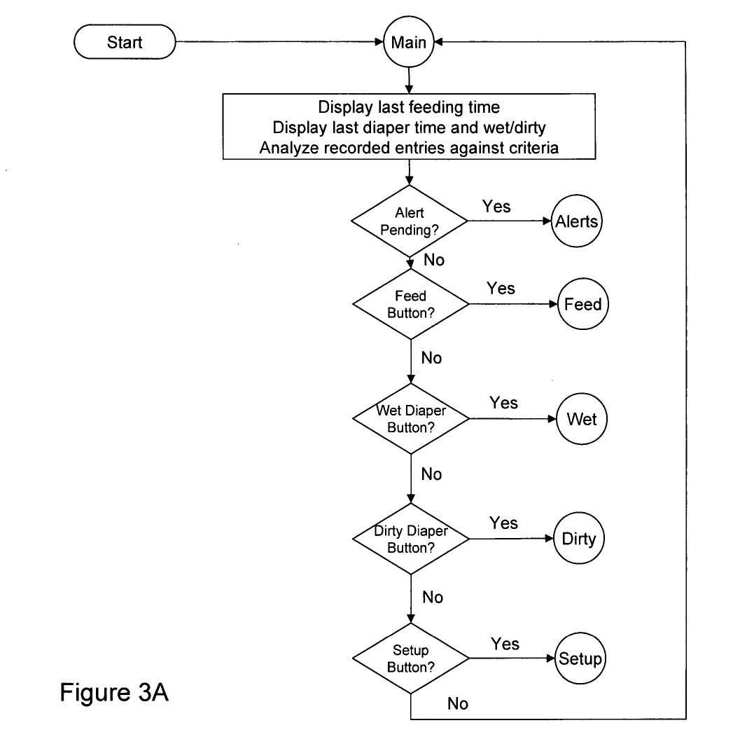

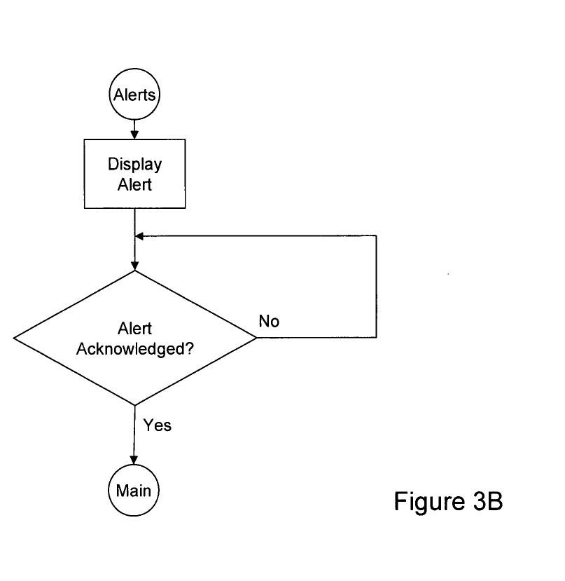

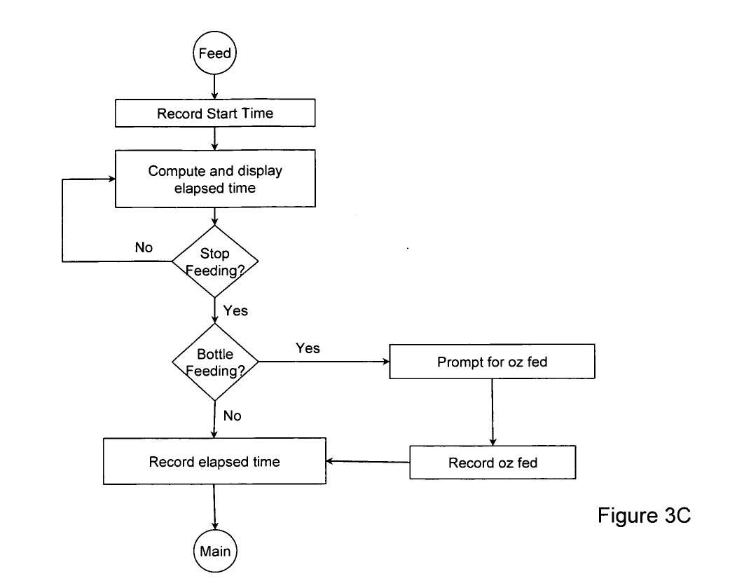

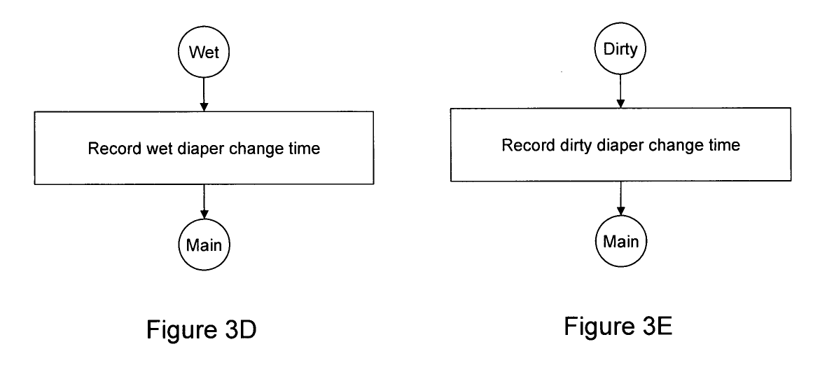

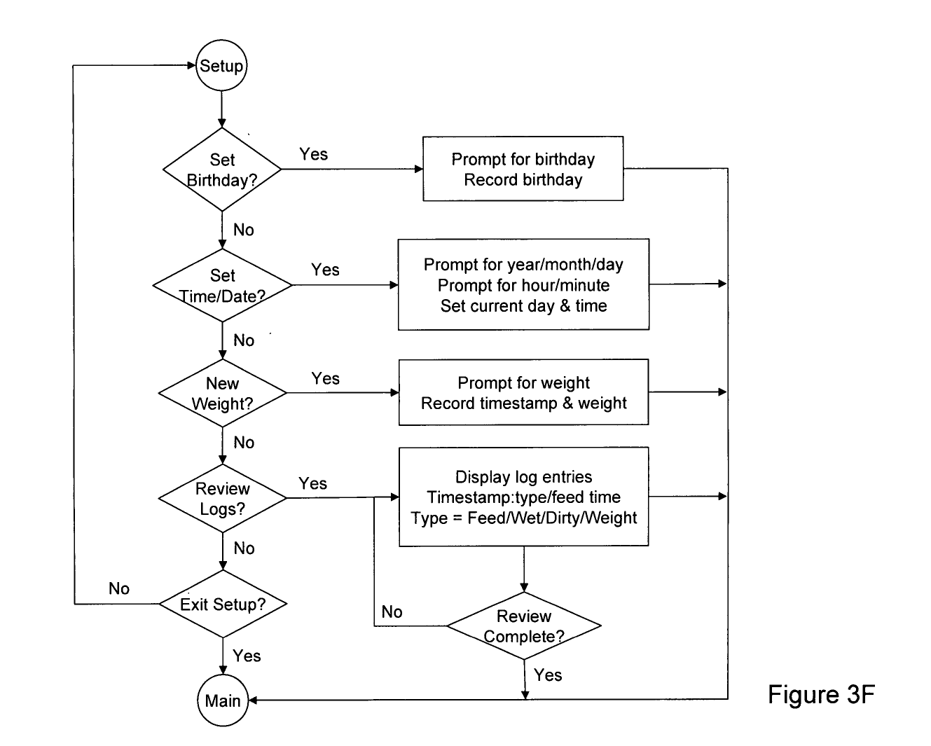

The user inputs may include pushing of the Feed, Wet, Dirty or Setup push buttons as shown in the flow diagram of FIG. 3A depending on whether an infant is to be profiled (Setup push button) or an event recorded (Feed, Wet, Dirty push buttons).

The user may depress the Setup push button which initiates the Setup menu on the display. An exemplary Set Up menu is shown in FIG. 4D. As shown in the flow diagram of FIG. 3F, the setup menu permits the user to set the birthday, initialize the time and date, input the infant's birth weight, and review logs of recorded events. (The actual method used to input this information may be varied as desired, but preferably utilizes the Wet/Up button and the Dirty/Down buttons 5 and 6 in combination with screen prompts of values, which values may be moved in one direction by depressing the Up button 5, and in an opposite direction by depressing the Down button 6, with a desired value being selected by depressing the Select button 7.) Once the infant has been initially profiled, the user may also record subsequent weights using the Setup menu. The Setup button 8 may be pushed a second time to exit Setup and return to the main menu. The “Setup” button 8 may also serve a dual function to cancel any menu to return to the main menu. Preferably, the time out is set for about 60 minutes for the Set up, Feed, Dirty and Wet sub-menus, at which time the device will return to the main menu or to a standby mode if there are no further inputs. (Preferably, the time-out setting is variable by the user.) Preferably, the Setup button 7 also has the dual purpose of a CANCEL function to terminate any menu and return to the main menu on the display.

The user may at any time select the Review recorded log option from the Setup menu. The Recorded log presents the recorded details for feeding times and durations, diaper changes, and weights. The log may be presented 3 lines at a time, and the user may scroll up and down the log with the Up 5 and Down 6 buttons. The device 100 may be connected by known means to a printer, so that desired information contained therein may be printed. The printout may include a cumulative history or other recorded data.

The Feed push button 4 begins a feeding cycle as shown in FIG. 3C. For recording a feeding event, the user pushes the feed push button 4 which causes the clock to record the feeding start time and the microprocessor to begin computing and displaying the elapsed time since the feeding began, and prompts a feeding menu such as shown in FIG. 4C to be presented on the display. Preferably, the elapsed time changes continuously at selected intervals. Although the feeding menu in FIG. 4C shows the elapsed time in hours and minutes, any other selected interval may be used. When nursing stops, the user may scroll (using the Up 5 and Down 6 buttons) to the Stop Breast Feeding option shown on the display and may select it by depressing the Select button 7, and the elapsed time is saved to memory and the device 100 returned to the main menu (see FIG. 4A). If the user selects the Bottle Feeding option from the feeding menu (see FIG. 4C), the user is prompted for the amount fed, in ounces, and then returned to the main menu. (It should be noted that this information is preferably entered using a combination of screen displays and the Up 5, Down 6, and Select 7 buttons, as described above for other inputting functions.) For a bottle feeding, the amount fed rather than elapsed time is saved along with the start of the actual feeding time.

For recording a diapering event, the user may depress the appropriate Wet and/or Dirty buttons 5 and/or 6 at the time of the diaper change. Depression of either of the Wet or Dirty buttons 5 or 6 causes the processor to record the time at which the wet or dirty diaper was changed as shown in FIGS. 3D and 3E.

The microprocessor continuously analyzes the recorded actual values against the target values. The microprocessor restarts a new counting process whenever the feeding, wet or dirty push buttons are pushed. Thereafter, the microprocessor calculates and analyzes the actual values and determines how they measure against the target values. The microprocessor records and saves in memory the frequency and duration of feedings, and the frequency of wet and dirty diapers.

An alert message is posted on the display and the LED light begins blinking if the target values are not met. An alert should be presented if, for example:
1. the total nursings in the previous 24 hours are less than 8;
2. the total feeding time over the previous 24 hours is less than 15 minutes×8 nursings with no supplemental feedings;
3. the breast feeding times have been deficient, and the infant has not been supplemented with adequate bottle feedings;
4. the time is within 3 days of birth, and there have been less than 1 wet diaper in previous 24 hours;
5. the time is beyond 3 days of birth, and there have been less than 6 wet diapers in previous 24 hours; or
6. there have been less than 2 soiled diapers (bowel movements) in previous 24 hours.
(Of course, one or more of these target values may be varied, or the personal information analyzed or changed, to reflect a change in standards or, perhaps, to adapt to the special needs of a particular infant.)

If alerts are identified, an Alert menu will be presented on the display with the specific alert or alerts identified as shown in FIG. 4B. The ALERT light emitting diode (LED) blinks on and off to notify the user. The alert may be cleared from the display when acknowledged by the user which then returns the device to the main menu as shown in FIG. 3B. If infant weights are entered, the total weight gain over a previous time period may be analyzed against the target values for expected weight gain. An alert may be posted if the total weight gain does not meet target values for expected weight gain. For example, an alert may be posted if the infant does not gain at least four ounces per week after the fourth week of life. The device 100 may further or alternatively include an audible alert (not shown).

When not in use, the device 100 remains in standby, or power-saving mode. Much of the device's time will be in the power saving mode. Before entering standby mode, the device will store all newly captured data to the storage memory. The LCD display may be turned off. The microprocessor continues to maintain the internal clock and monitor for warning (alert) conditions even in standby mode. Any unacknowledged alerts may be saved and the warning may be posted with the ALERT LED.

Although its use with a breast feeding infant has been described, the device and method may be used to assess adequacy of nutrition or hydration when target values have been identified. Although this invention has been described as useful in monitoring a breast feeding infant's nutritional health, it is to be appreciated that the device and method may be used to monitor intake for other physiological conditions.

The device may also be linked to communication links such as satellite, telephone, cable or the like to transmit or retrieve data relevant to the nutritional health of an individual, including transmission of data to a health care provider. The logged history may be downloaded to a personal computer for charting and/or trend analysis.

Although a particular embodiment of the invention has been described in detail for purposes of illustration, various modifications may be made without departing from the spirit and scope of the invention. Accordingly, the invention is not to be limited, except as by the appended claims.

1. A breast feeding monitoring device for monitoring the nutritional health of a breast feeding infant comprising, in combination:
a housing;
a microprocessor located within said housing;
memory accessed by said microprocessor;
wherein said memory stores a plurality of items of personal data relating to nutritional health of a breast feeding infant;
wherein said memory further stores relevant target values for nutritional health of a breast feeding infant;
a display located on a surface of said housing for providing a visual display of information relating to said nutritional health of a breast feeding infant; and
individual data inputting means on said housing for inputting into said memory said personal data.

2. The device of claim 1 wherein said plurality of items of personal data includes information relating to a number of breast feedings within a defined period of time, and wherein said relevant target values includes a target number of breast feedings within said defined period of time.

3. The device of claim 2 wherein said plurality of items of personal data includes information relating to a duration of said breast feedings, and wherein said relevant target values includes a target duration of said breast feedings.

4. The device of claim 1 wherein said plurality of items of personal data includes information relating to an amount of pumped breast milk or formula provided to said breast feeding infant within a defined period of time.

5. The device of claim 1 wherein said plurality of items of personal data includes information relating to a number of wet diapers within a defined period of time, and wherein said relevant target values includes a target number of wet diapers within said defined period of time.

6. The device of claim 1 wherein said plurality of items of personal data includes information relating to a number of dirty diapers within a defined period of time, and wherein said relevant target values includes a target number of dirty diapers within said defined period of time.

7. The device of claim 1 further comprising an alert that is activated upon a departure by said breast feeding infant from at least one of said relevant target value.

8. The device of claim 1 further comprising means for recording whether a breast feeding session was on the left breast or right breast.

9. A method for monitoring the nutritional health of a breast feeding infant comprising the steps of:
providing a monitoring device comprising, in combination:
a housing;
a microprocessor located within said housing;
memory accessed by said microprocessor;
wherein said memory stores a plurality of items of personal data relating to nutritional health of a breast feeding infant;
wherein said memory further stores relevant target values for nutritional health of a breast feeding infant;
a display located on a surface of said housing for providing a visual display of information relating to said nutritional health of a breast feeding infant; and
individual data inputting means on said housing for inputting into said memory said personal data;
accepting from a user of said device inputting of said plurality of items of personal data relating to said nutritional health of said breast feeding infant; and
said device comparing said inputted plurality of items of personal data to said relevant target values.

10. The method of claim 9 wherein said step of accepting from said user inputting of said plurality of items of personal data comprises the step of accepting inputting of information relating to a number of breast feedings within a defined period of time.

11. The method of claim 10 wherein said step of accepting from said user inputting of said plurality of items of personal data comprises the step of accepting inputting information relating to a duration of said breast feedings.

12. The method of claim 10 wherein said step of accepting from said user inputting of said plurality of items of personal data comprises the step of accepting inputting information relating to an amount of formula provided to said breast feeding infant within a defined period of time.

13. The method of claim 9 wherein said step of accepting from said user inputting of said plurality of items of personal data comprises the step of accepting inputting information relating to a number of wet diapers within a defined period of time.

14. The method of claim 9 wherein said step of accepting from said user inputting of said plurality of items of personal data comprises the step of accepting inputting information relating to a number of dirty diapers within a defined period of time.

15. The method of claim 9 wherein said device further comprises an alarm that is activated upon a departure by said breast feeding infant from at least one said relevant target value and further comprising the step of activating said alert upon said departure.

16. The method of claim 9 further comprising means for accepting the inputting of information identifying whether a breast feeding session was on the left breast or right breast.

17. A method for monitoring the nutritional health of a breast feeding infant comprising the steps of:
providing a monitoring device comprising, in combination:
a housing;
a microprocessor located within said housing;
memory accessed by said microprocessor;
wherein said memory stores a plurality of items of personal data relating to nutritional health of a breast feeding infant;
wherein said memory further stores relevant target values for nutritional health of a breast feeding infant;
a display located on a surface of said housing for providing a visual display of information relating to said nutritional health of a breast feeding infant; and
individual data inputting means on said housing for inputting into said memory said personal data;
accepting from a user of said device inputting of information relating to a number of breast feedings within a defined period of time for said breast feeding infant;
accepting from said user of said device inputting of information relating to a duration of said breast feedings;
accepting from said user of said device inputting of information relating to a number of wet diapers for said breast feeding infant;
accepting from said user of said device inputting of information relating to a number of dirty diapers for said breast feeding infant; and
said device comparing said inputted plurality of items of personal data to said relevant target values.

18. The method of claim 17 further comprising the step of accepting from said user inputting of information relating to an amount of formula provided to said breast feeding infant within a defined period of time.

19. The method of claim 17 wherein said device further comprises an alert that is activated upon a departure by said breast feeding infant from at least one said relevant target value and further comprising the step of activating said alert upon said departure.

20. The method of claim 17 further comprising means for accepting the inputting of information identifying whether a breast feeding session was on the left breast or right breast.
